(19) United States
(12) Patent Application Publication
(10) Pub. No.: US 2025/0185643 A1
(43) Pub. Date: Jun. 12, 2025

(54) MOBILE WEED CONTROL/ DESUCKERING EQUIPMENT

(71) Applicant: Spezia S.r.L., Pianello Val Tidone (IT)

(72) Inventor: Giancarlo Spezia, Nibbiano (IT)

(21) Appl. No.: 18/843,292

(22) PCT Filed: Feb. 1, 2023
(86) PCT No.: PCT/EP2023/052442

§ 371 Date: Sep. 2, 2024

(30) Foreign Application Priority Data
Mar. 2, 2022 (IT) 102022000003935

(51) Int. Cl. A01M 21/04; B05B 1/24; B05B 7/00

(52) U.S. Cl. CPC A01M 21/04; B05B 1/24; B05B 7/0018

(57) ABSTRACT

Mobile weed control/desuckering equipment, particularly for tree crops, such as vineyards, orchards, and the like, characterized by comprising: a water containment tank; heating means of said water; a foaming substance containment tank; generating means of forced air; heating means of said forced air; a foam generating device; a duct for forced air connecting said forced air generating means to said foam generating device, said heating means of said forced air being positioned in said duct; first conveying means of said water from the corresponding containment tank to said heating means of said water; second conveying means of said water from the corresponding heating means to said duct for forced air upstream of said foam generating device and downstream of said heating means of forced air; transfer means of said foaming substance from the corresponding containment tank to said second water conveying means; a first injection device of a mixture of water and foaming substance from said second conveying means into said duct for forced air; distribution means of said foam; control means of said mobile weed control/desuckering equipment.

The present invention relates to mobile weed control/desuckering equipment for tree crops, particularly vineyards, orchards, and the like. More particularly, the present invention relates to thermal foaming weed control/desuckering equipment of improved type, in which the weed control/desuckering action does not take place by mechanical or chemical effect but by the thermal effect of a foam produced with said equipment.

Therefore, the present invention is destined to be used in the agricultural sector for the production of fruit/vegetables, and the like, for example in vineyards, and more generally in crops, above all tree crops, where there is the need to carry out weed control/desuckering operations to improve the quality and/or the quantity of the products of said tree crops.

Already in the 1970s the advent of “industrial” viticulture and the need to reduce production costs through the management of large surface areas of vineyards with a low number or workers per surface unit oriented under-row management of the vineyard, i.e., elimination of weeds and suckers, toward chemical treatment methods, to the detriment of mechanical removal methods. In more recent times, the sustainable development of vine and grape production (just as production of other crops, above all tree crops) has imposed increasing attention towards respect for the environment. Also in view of considerable media pressure on this subject, the reduction or total elimination of the use of herbicides and desiccants is therefore a need that is particularly pertinent not only to organic wineries or to those practicing integrated control, but in general throughout the farming sector.

Therefore, there has recently been a significant reversal of trends, with various attempts by farms to return to mechanical operations capable of guaranteeing quality of work and acceptable execution times with respect for environmental requirements, the application of which has however proved to be very difficult.

In fact, in order to execute the operation correctly on machines that work by inserting their working members into the limited space between one stock and the next, the speed at which the operation is performed is greatly limited, rarely exceeding 3 km/h. Consequently, the operating capacity is often below 0.25 ha/h and costs become extremely high.

Undoubtedly higher travelling speeds can be obtained with weeding machines that do not work with mechanical members on the under-row between stocks, such as weed removal/desuckering machines that use flails, but in this case the stocks often undergo undesirable damage, promoting the spread of pathogens and virus diseases.

An alternative solution is thermal weeding: in this case the grass is heated until the proteins present therein become denatured. In this way as the grass is unable to photosynthesize it dries out in a few days. Known thermal techniques are flame weeding (heating the grass with a naked flame, the application of a steam jet or hot water (in some cases with the addition of oils or foams to retain the heat of the water on the weed leaf). All these solutions have been proved relatively unsuccessful due to the slow application speed, as denaturation of the proteins cannot be obtained at high speeds. Thermal solutions such as flame weeding have proved to be suitable for situations in which the growth of grass is limited and consequently only one treatment a year is required. The possibility of carrying out several treatments is in fact limited by the risk of the previously dried grass catching fire, thereby further limiting the diffusion of this practice. Recently, there have been proposals for an approach to the problem that is not based on mechanical or chemical actions, but rather on thermal actions, using foams with the addition of water at high temperatures which are deposited on the above-ground part of the plant to be eliminated in order to exploit the heat trapped in the foam bubbles to eliminate the vegetation from the ground at the base of the stocks.

However, although these solutions seem to have a certain degree of efficacy for controlling weeds in public parks, the solutions proposed have not proved to be sufficiently effective for application in the tree crop sector, such as vineyards, orchards, and the like, due to the enormous amounts of water required.

In particular, to date no weed control/desuckering equipment is known capable of producing foams at temperatures that are relatively high and sufficiently stable over time to ensure effective weed control/desuckering action on tree crops, such as vineyards, orchards, and the like.

It would therefore be desirable to avail of weed control/desuckering equipment capable of performing adequate weed control/desuckering action, overcoming the problems of the prior art.

In particular, it would be desirable to avail of weed control/desuckering equipment in which the weed control/desuckering action is not of mechanical type.

Moreover, it would be desirable to avail of weed control/desuckering equipment in which the use of chemical herbicide agents is not required.

An object of the present invention is therefore to provide mobile weed control/desuckering equipment capable of operating with relatively high speeds.

A further object of the present invention is to provide weed control/desuckering equipment mobile in which weed control and desuckering are not carried out mechanically.

Yet another object of the present invention is to provide mobile weed control/desuckering equipment in which the weed control and desuckering action is carried out without the use of herbicide chemical agents and the like.

One more object of the present invention is to provide mobile weed control/desuckering equipment in which the weed control and desuckering action take place by thermal effect using foams at relatively high temperatures and that are sufficiently stable over time, which also have the task of supplying heat and maintaining it for the time required to achieve denaturation of the proteins.

Another object of the present invention is to provide mobile weed control/desuckering equipment that is highly reliable and is easy to produce at competitive costs.

The aforesaid and other objects, which shall be apparent from the description below, are achieved by means of mobile weed control/desuckering equipment, particularly for tree crops, such as vineyards, orchards, and the like, according to the present invention, characterized by comprising:
a water containment tank;
heating means of said water;
a foaming substance containment tank;
generating means of forced air;
heating means of said forced air;
a foam generating device;
a duct for forced air connecting said forced air generating means to said foam generating device, said heating means of said forced air being positioned in said duct;
first conveying means of said water from the corresponding containment tank to said heating means of said water;
second conveying means of said water from the corresponding heating means to said duct for forced air upstream of said foam generating device and downstream of said heating means of forced air;
transfer means of said foaming substance from the corresponding containment tank to said second water conveying means;
a first injection device of a mixture of water and foaming substance from said second conveying means into said duct for forced air;
distribution means of said foam;
control means of said mobile weed control/desuckering equipment.

In this way, mobile weed control/desuckering equipment that satisfies the aforesaid objects is provided.

The equipment according to the present invention in fact has a limited impact on the environment, due to replacement of herbicide chemical products with hot water and foaming compounds, particularly 100% biocompatible/biodegradable surfactant compounds. For the purposes of the present invention, the term “biocompatible” is meant to indicate substances without harmful effects for humans, while the term “biodegradable” is meant to indicate substances that do not accumulate in the environment and that are able to degrade autonomously and/or through other agents, such as bacteria and microbic species in general.

Foaming substances that can be used in the equipment of the invention can be of different types, the principal requirement being their stability at the operating temperatures and their suitability to treat plant crops from a regulatory point of view. In substance, surfactants of various types can be used: anionic, cationic, non ionic, amphoteric and these can be both of natural or synthetic origin, providing they are stable at the operating temperatures.

Biosurfactants are particularly suitable, i.e. those derived from chemical reactions on renewable raw materials of animal and plant origin, such as:
substances derived from the forestry industry: lignosulphonates, hemicelluloses, partially depolymerized modified celluloses, modified starches;
substances derived from resinous material: sterols, ethoxylated sterols;
substances derived from amino acids, lactic acid and ascorbic acid;
substances derived from natural products recovered from industrial and non-industrial processes: saponins, lecithins, casein, glycolipids, lipopeptides, lipoproteins, phospholipids;
polymeric surfactants (emulsan, liposan, alasan, lipomanan).

A second class of particularly suitable biosurfactants instead includes compounds created entirely from natural resources through biological processes (fermentations with products added to the fermentation broth) or produced enzymatically.

In particular, surfactants that should be considered particularly suitable are those obtained from protein hydrolysis, such as: plant hydrolysates obtained by enzymatic hydrolysis of wheat proteins; protein hydrolysates obtained by enzymatic hydrolysis of rice; protein hydrolysates of animal origin obtained by enzymatic hydrolysis of wools (keratin); protein hydrolysates deriving from silk proteins obtained by enzymatic hydrolysis.

From the point of view of cost for carrying out weed control and desuckering operations, as with the equipment according to the present invention there are no working members in movement between stocks, but only the passage between the rows for distribution of the hot foam in the under row, the speeds at which the operation is carried out can reach those used for chemical weeding. Therefore, with respect to mechanical solutions, the operating capacity is significantly improved.

In practice, with the equipment of the present invention, the speed can be high, as the foam is produced and deposited on the ground, leaving the foam to do the work of heating and maintaining the heat for the next few seconds. This is therefore an indirect application method, while other known thermal methods are of direct type.

Moreover, the absence of mechanical parts in movement avoids possible damage to the base of the stock and resulting problems of plant health.

As better illustrated below, with respect to conventional thermal weeding technologies using foams, thanks to the particular arrangement of the various devices of which it is composed and the related control system, with the equipment according to the invention it is possible to obtain foams at sufficiently high and sufficiently stable temperatures to guarantee an effective weed control/desuckering action and/or without the need to use unsustainable amounts of water.

In practice, through the control means it is possible to control one or more of the operational variables (for example liquid flow rate, forced air flow rate, foam density, temperature of the air and/or of the liquid, temperature of the foam produced, amount of foam dispensed, and the like) and to monitor one or more physical parameters of the system (temperature and/or pressure both of the liquid and of the forced air being delivered, characteristics of the foam, such as density, air and liquid temperature, and the like), in order to obtain a foam that is stable at the desired temperature.

In particular, it was in fact seen that the best results can be obtained when heating and control of the temperature of the forced air is separate from that of the water and/or of the water/foaming substance mixture. For example, the forced air, for example produced by a suitable fan, can be heated efficiently using electric heating elements appropriately positioned in the duct for forced air downstream of the forced air generating means, while the water can be heated by making it pass through a heat exchanger, for example a coil, positioned in a diesel oil or gas boiler.

In this way, it was seen that good results can be obtained by heating the forced air to a temperature >50° C., preferably >100° C., while the temperature of the water and of the water/foaming substance mixture is maintained at a temperature >65° C., preferably >70° C., more preferably >80° C.

In a preferred embodiment of the mobile weed control/desuckering equipment according to the invention, the control means can be programmed to determine switch on/switch off of said heating means of the water according to on/off cycles determined in real time.

In particular, the control means can advantageously be programmed to determine switch on/switch off of said heating means of the water according to on/off cycles that are determined as a function of the inlet temperature of the water, and/or of the outlet temperature of the water from the corresponding heating means-particularly as a function of the incremental difference of the outlet temperature of the water from the corresponding heating means—and of the desired temperature of the water delivered from said heating means.

In fact, it has been seen that by switching off the heating means of the water, for example a diesel oil boiler, on the basis of a threshold value controlled by a thermostat (also a smart thermostat), due to the considerable length of the coil, the thermal flywheel is such that there is further heating of the water in the first stage even without a flame, followed by a sudden drop in temperature that does not stop even when the flame is switched on again. The great variability of the inlet temperature of the water in the boiler can make this phenomenon every more serious. This sinusoidal trend of the temperature of the water also has a very negative influence on the temperature of the foam, and hence also on its stability.

By setting on/off cycles on the boiler, which can be variable as a function of the inlet temperature of the water into boiler, the problem is avoided or, in any case, minimized to negligible levels. Using work cycles of the boiler, with switch-offs ranging from 1 to several seconds and switch on cycles, also variable (for example 2-50 secs) it is possible to reach and maintain the target temperature, without switch-offs caused by overtemperature, resulting in the sinusoidal trend of the temperature. In practice, the boiler is switched on and off with control in real time, ensuring a constant outlet temperature. In this way it is possible to work with constant target temperatures (for example close to 100° C.) leaving thermostat switch-off as an overtemperature safety measure.

A particularly preferred embodiment of the mobile weed control/desuckering equipment according to the invention comprises third conveying means of the water connecting a point of said second conveying means upstream of the inlet of the transfer means of said foaming substance with said duct for forced air at a point downstream of said heating means of forced air and upstream of said first injection device of a mixture of water and foaming substance.

In practice, in this embodiment, a certain amount of water is collected from the conveying duct of the heated water before this is mixed with the foaming substance. This water is then sent to the duct for forced air and nebulized therein—for example by a second injection device of water—at a point upstream of the inlet into said duct of the mixture of water and foaming substance. In other words, in this preferred embodiment, the mixture of water and foaming substance is injected and nebulized in a current of forced air that contains a high percentage of steam.

It was in fact surprisingly found that in this way that air inside the bubbles tends to be saturated with water and the stability of the foam generated is significantly higher, also allowing slightly higher temperatures to be reached.

According to embodiments of the equipment according to the invention, described in detail below, it is possible to provide a first recirculation line of the water from said second conveying means of water to the corresponding containment tank. In this way, using a suitable three-way valve, it is possible to implement a pre-heating step in which the water, after passing through the heating means is recycled into the corresponding containment tank until a predetermined operating temperature is reached.

Likewise, according to embodiments of the equipment of the invention described in detail below, it is possible to provide a second recirculation line of the water from said first conveying means of water to the corresponding containment tank, to be used when the weed control/desuckering process is temporarily interrupted, for example during an manoeuvre, and the boiler is temporarily switched off.

Typically, the first injection device of a mixture of water and foaming substance and/or the second injection device of water can advantageously comprise one or more nebulizing/atomizing nozzles of said mixture of water and foaming substance and/or of said water inside the duct for forced air.

In practice, the generation of foam in a mobile weed control/desuckering equipment according to the present invention can be obtained using suitable nebulizing/atomizing nozzles of the mixture of water and foaming substance inside the duct for forced air immediately upstream of the foam generating device.

This device can advantageously comprise a screen, typically provided with holes calibrated so as to give the bubbles a precise size, arranged substantially transversely to the direction of flow of said forced air. In practice, in this embodiment of the mobile weed control/desuckering equipment according to the present invention, a screen, for example a metal grid with mesh of suitable size and shape, is positioned inside the foam generating device in a manner substantially transverse to the direction of flow of the forced air. The screen is constantly wetted with the mixture of water and foaming substance, by means of one or more nebulizing/atomizing nozzles of the mixture of water and foaming substance positioned immediately upstream of said screen with respect to the direction of flow of the forced air. The current of forced air, passing through the wetted grid, thus generates a considerably homogenous and thick foam, which is a very important condition for the transmission and persistence of heat on the plant material to be inactivated.

The distribution means of the foam can advantageously be provided with devices for lowering the grass and conveying the foam so as to form a covering of a constant height.

One of the specific features of the weed control/desuckering equipment of the invention is given by the fact of being mobile. For this purpose, the equipment can advantageously comprise means for operational coupling with a means of transport, particularly with a farm tractor.

For example, by operating with heating elements for heating of the forced air, the electricity generating devices (for example 48V DC) and the heating means of the water can be positioned on the rear part of a tractor on a frame to which tank trailer for containing clean water is attached (or a tank without wheels supported by the back lifter of the tractor in the case in which turning spaces are narrow). Tanks and related devices (for example pumps) for the surfactant can advantageously be positioned in the front part of the machine.

This configuration allows the need for manoeuvrability, ergonomics, safety and weight balancing to be combined, obtaining a compact and balanced layout and providing the operator with perfect visibility of the work carried out from the driving seat.

In an embodiment of the mobile weed control/desuckering equipment according to the present invention, the foam distribution means can be positioned laterally to the tractor and dispense the foam in a direction substantially perpendicular to the direction of travel of the tractor.

In an alternative embodiment, particularly suitable for row systems, it is possible to use an upside down U-shaped structure, described in more detail below, which allows the row to be surrounded and the foam to be deposited on the ground under the row, in order to prevent weeds from coming into contact with the grapes.

For applications other than vineyards, other types of front support can be provided on the farm tractor to carry the foam generator devices in a position favourable for the purposes of the specific crop.

For example, it is possible for the equipment to be assembled on a truck or other self-propelled vehicle for other uses, such as in the flowerbeds of parks, gardens and the like, or for weeding operations in road or rail systems.

In general, the relative arrangement of the various elements and devices forming the equipment according to the present invention can be varied greatly as a function of requirements.

Operational management of the equipment can be automated, even heavily. In fact, the control means of the equipment can be operationally connected to said water containment tank, and/or to said heating means of said water, and/or to said foaming substance containment tank, and/or to said generating means of forced air, and/or to said heating means of said forced air, and/or to said foam generating device, and/or to said first conveying means of said water, and/or to said second conveying means of said water, and/or to said transfer means of said foaming substance, and/or to said first injection device, and/or to said second injection device, and/or to said foam distribution means.

For example, the control means of the equipment can control the switch-on logic of the various devices, for example: do not switch on the boiler if water is not circulating, do not switch on the heating elements if the fans are not running, recirculate preheating until the temperature is reached, thereby exercising parameter regulation functions and safety procedure implementation functions.

Further features and advantages of the present invention will be more apparent from the description of some embodiments of weed control/desuckering equipment according to the present invention, illustrated purely by way of non-limiting example in the accompanying drawings, wherein:

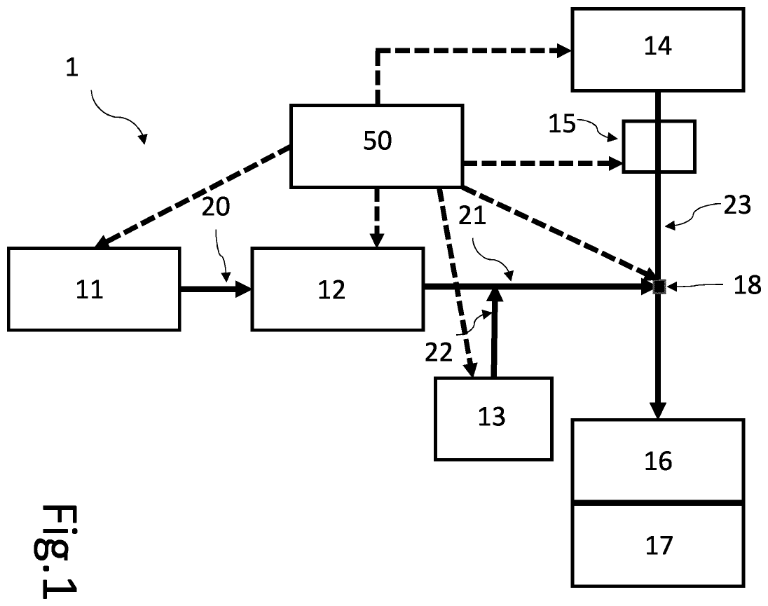

FIG. 1 illustrates a block diagram of a general embodiment of weed control/desuckering equipment according to the present invention;

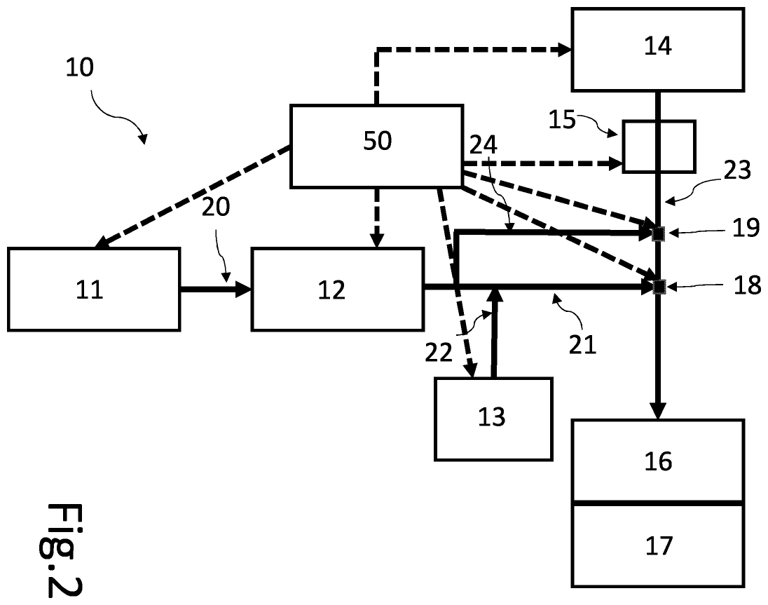

FIG. 2 illustrates a block diagram of a particular embodiment of weed control/desuckering equipment according to the present invention;

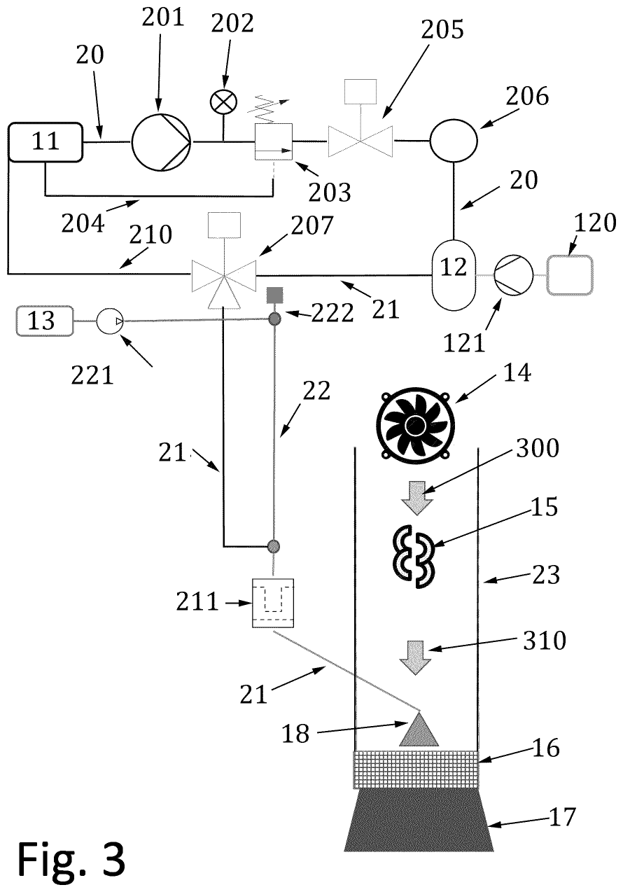

FIG. 3 schematically illustrates a first embodiment of weed control/desuckering equipment according to the present invention;

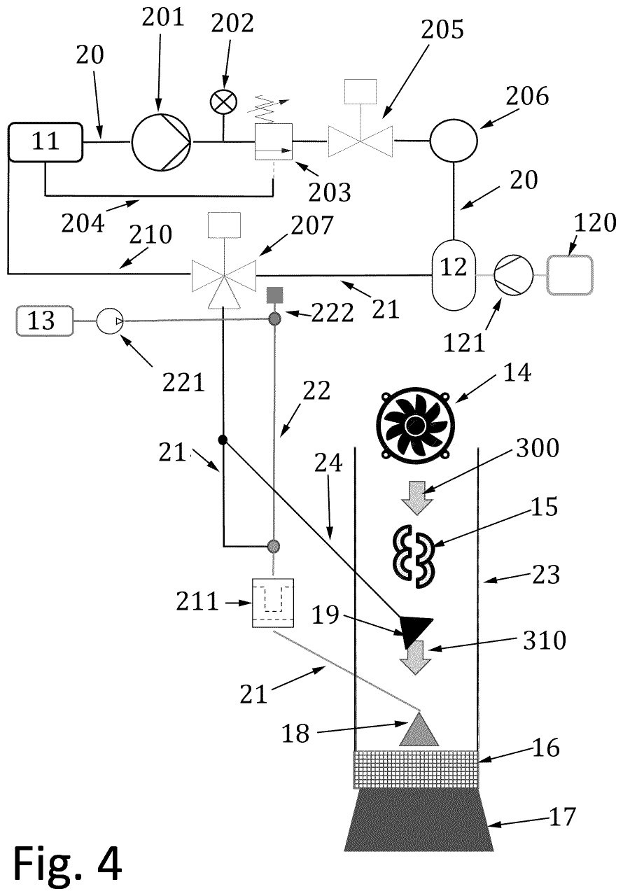

FIG. 4 schematically illustrates a second embodiment of weed control/desuckering equipment according to the present invention;

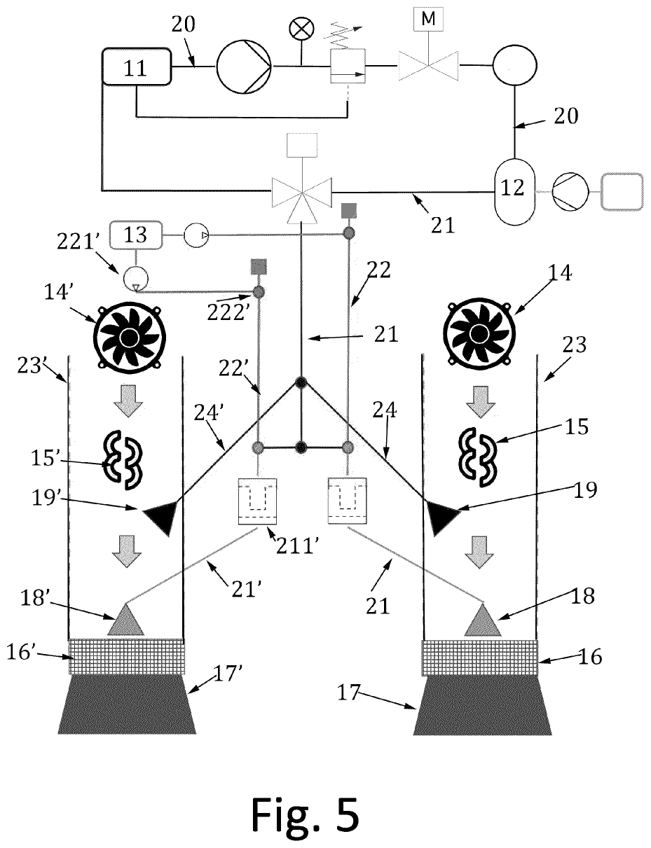

FIG. 5 schematically illustrates a third embodiment of weed control/desuckering equipment according to the present invention.

With reference to the accompanying figures, the mobile weed control/desuckering equipment according to the present invention, designated with the reference numbers 1, 10, 100 in the various embodiments, comprises, in its most general embodiment, a water containment tank 11.

The weed control/desuckering equipment 1, 10, 100 according to the present invention further comprises first conveying means 20 of said water (for example a pipe made of suitable material) connecting the corresponding containment tank 11 with suitable heating means 12, for example a diesel oil boiler provided with a heat exchanger, for example a coil, inside which the water is circulated. The heating means 12 are used to take the water to the desired temperature, which is preferably above 70° C. and advantageously close to 100° C. so as to produce foam at similar temperatures and allow denaturation of the proteins forming the plant matter to be treated.

At the outlet of the heating means 12 the heated water is sent to a device 16 capable of generating foam through second conveying means 21 (for example a pipe made of a suitable material) of said water, as better described below.

The foaming solution is obtained by introducing a foaming substance contained in a corresponding containment tank 13 into the water heated inside the conveying duct 21, through transfer means 22 of said foaming substance, for example formed by a pipe made of suitable material provided with specific pumping devices.

With particular reference to FIGS. 3-5, in order to preserve the structure of the foaming substance as much as possible, it is greatly preferable to add this substance to the flow of pressurized water in the duct 21 as far downstream as possible. Advantageously, the addition of foaming substance to the water can be carried out in a strictly controlled manner by providing the duct of the transfer means 22, 22′ with an electromechanical dosing pump 221, 221′ operated with electric impulses, for example at 48V DC. At each impulse, foaming substance is pumped at a volume that depends on the backpressure of the water in the conveying duct 21 that must be overcome by the pump. In this regard, a calibration routine has been developed in order for the percentage of foaming agent (for example up to a maximum of around 3% of foaming substance in the water) introduced into the circuit to correspond with the frequency of impulses controlled by the control means 50 (from 100 to 180 imp/min).

The transfer means 22, 22′ can also comprise an air bleed valve 222, 222′ suitably positioned on the transfer duct of said foaming substance. Further one-way valves can be provided to prevent the water from flowing towards the foaming agent pumps.

The weed control/desuckering equipment 1, 10, 100 according to the present invention further comprises generating means 14, 14′ of forced air 300, 310 provided with heating means 15, 15′ of said forced air 300, 310.

Preferably, the forced air generating means comprise one or more electric fans 14, 14′, while the heating means comprise one or more heating elements 15, 15′. Electrical power supply of the forced air generating means 14, 14′ and of the heating means 15, 15′ is particularly advantageous as it allows temperatures and flow rates to be modulated so that a foam that is more or less voluminous can be generated. The movement dynamics of the foam are in fact influenced by the size of the bubbles that can be varied as a function of the flow rate and of the temperature of the forced air. Regulation of the temperature of the forced air can, for example, take place through solid state regulation of the heating elements.

The forced air 300 generated by the generating means 14, 14′ is sent to a duct 23, 23′ for forced air 300, 310 connecting said forced air generating means 14, 14′ to a foam generating device 16, 16′. In this duct 23, 23′, the forced air 300, 310 is heated by the heating means 15, 15′.

As illustrated in the accompanying figures, introduction of the mixture of hot water and foaming substance from the second conveying means 21 into the forced air duct 23, 23′ takes place in a point immediately upstream of the foam generating device 16, 16′ and downstream of the heating means 15, 15′ of the forced air. In other words, the mixture of hot water and foaming substance is nebulized into the flow of hot air 310 immediately before the foam generating device 16, 16′.

The supply of the mixture of water and foaming substance into the flow of forced hot air 310 in the duct 23, 23′ advantageously takes place through a first injection device 18, 18′, which comprises one or more nebulizing/atomizing nozzles of said mixture of water and foaming substance immediately upstream of the foam generating device 16, 16′.

The foam generating device 16, 16′ can advantageously comprise a screen arranged substantially transversely to the direction of flow of said forced air 300, 310, in accordance with what was described previously. In any case, other types of foam generating devices could also be used.

The weed control/desuckering equipment 1, 10, 100 according to the present invention further comprises distribution means 17 of said foam, which can advantageously be provided with devices for lowering the grass and conveying the foam so as to form a covering of constant height.

With reference to the diagrams of FIGS. 1 and 2, the weed control/desuckering equipment 1, 10, 100 is further provided with control means 50 which can be operatively connected to said water containment tank 11, and/or to said heating means 12 of said water, and/or to said foaming substance containment tank 13, and/or to said generating means 14 of forced air 300, 310, and/or to said heating means 15 of said forced air 300, 310, and/or to said foam generating device 16, and/or to said first conveying means 20 of said water, and/or to said second conveying means 21 of said water, and/or to said transfer means 22 of said foaming substance, and/or to said first injection device 18, and/or to said second injection device 19, and/or to said distribution means 17 of said foam.

In particular, in a preferred embodiment of the weed control/desuckering equipment 1, 10, 100 of the invention said control means 50 are operatively connected to the heating means 12 of the water so as to determine the switch on/switch off thereof according to calculated on/off cycles, as previously illustrated. These on/off cycles can advantageously be calculated by the control means 50 as a function of the inlet temperature of the water into the corresponding heating means 12 and/or of the desired outlet temperature of the water from said heating means 12, thereby ensuring maintenance of a substantially constant temperature and preventing the sinusoidal trends of the temperature and related problems described previously.

With reference to FIGS. 2, 4 and 5, a particularly preferred embodiment of the mobile equipment 1, 10, 100 of the invention includes the presence of third conveying means 24, 24′ of the water connecting a point of said second conveying means 21 upstream of the inlet of the transfer means 22, 22′ of the foaming substance into said duct 23, 23′ of forced air 300, 310 at a point downstream of said heating means 15, 15′ of forced air 300, 310 and upstream of said first injection device 18, 18′ of a mixture of water and foaming substance.

In practice, in this embodiment, clean hot water is collected from the duct 21 before input of the foaming substance and is injected into the flow of hot forced air 310 upstream of the injection point of the mixture of water and surfactant substance into the duct 23, 23′. The supply of hot water into the flow of forced hot air 310 in the duct 23, 23′ advantageously takes place through a second injection device 19, 19′, which comprises one or more nebulizing/atomizing nozzles of hot water, thereby saturating the hot air 310 with steam and obtaining the advantages in terms of stability of the foam described previously.

With reference to FIGS. 3, 4 and 5, in some embodiments of the equipment 1, 10, 100 according to the invention, the second conveying means 21 of the water advantageously comprise a three-way valve 207 to which a first recirculation line 210 of the water from said second conveying means 21 to the corresponding containment tank 11 is connected. In this way, as described previously, it is possible to implement a pre-heating step in which after passing through the heating means 12 the water is recycled in the related containment tank 3 until reaching a predetermined operating temperature. At this point, the first recirculation line 210 can be disabled by operating the three-way valve 207 and the hot water can flow into the rest of the equipment through the second conveying means 21.

The equipment according to the invention can also be provided with further devices for controlling temperatures and flows, and more generally the operating conditions. For example, with reference to FIGS. 3, 4 and 5, the first water conveying means 20 can be provided with pumping means 201, for example a diaphragm pump, with one or more pressure sensors 202, and with a maximum pressure valve 203. Starting from said maximum pressure valve 203, it is possible to produce a second water recirculation line 204 from said first water conveying means 20 to the corresponding containment tank 11.

In this way, when the weed control/desuckering process is temporarily interrupted, for example during a manoeuvre, and the heating means of the water 12 are temporarily switched off, the water can be recycled to the containment tank 3 through the maximum pressure valve 203.

In the case in which the heating means of the water 12 consists of a boiler, for example a diesel oil boiler, a fuel tank 120 and related fuel suction pump 121 will normally be provided.

As mentioned above, the mobile weed control/desuckering equipment 1, 10, 100 of the invention can advantageously comprise means for operational coupling with a means of transport, particularly with a farm tractor, and the related arrangement of the various elements and devices forming the equipment 1, 10, 100 according to the present invention can vary greatly as a function of requirements.

For example, with reference to FIG. 5, in an embodiment of the mobile weed control/desuckering equipment 1, 10, 100 of the invention particularly suitable for row systems, an upside down U-shaped structure is used, the vertical arms of which are formed by the forced air ducts 23 and 23′ with the corresponding foam generating devices 16, 16′ and the distribution means 17, 17′ of said foam positioned at the lower end.

Each duct 23, 23′ is connected to corresponding forced air generating means 14, 14′ and houses therein the related heating means 15, 15′ of said forced air. Alternatively, according to another embodiment, not illustrated, it is possible to provide one system for forced air generation and heating that sends hot air to both the ducts 23 and 23′.

The hydraulic circuit formed by the second conveying means 21 of the water is split, with a further branch 21′ directed towards the duct 23′ for forced air, as are the transfer means 22 of said foaming substance, which have a further branch 22′ that leads into the branch 21′. Likewise, also the third conveying means 24 of the water are split and have a further branch 24′ directed towards the duct 23′ for forced air.

In substance, the basic configuration is repeated on the two vertical branches of the upside down U, obtaining a structure that allows the row to be effectively surrounded and the foam to be deposited on the ground underneath the row on both sides thereof.

As can be understood from the description and from the accompanying drawings, the technical solutions adopted by the present invention make it possible to fully achieve the pre-set aims and objects, obtaining mobile weed control/desuckering equipment of undoubted usefulness and which is practical to use.

The embodiments described for the present invention are susceptible to numerous modifications and variations falling within the scope of the same innovative idea defined by the appended claims. In practice, the materials used and the contingent shapes and dimensions can be any, according to requirements and to the state of the art.

1-10. (canceled)

11. An apparatus for mobile weed control and/or desuckering of tree crops, the apparatus comprising:
a water containment tank;
means for heating water conveyed via first conveying means from the water containment tank;
a foaming substance containment tank;
means for generating forced air;
means for heating the forced air;
a foam generating device;
a forced air duct connecting the means for generating forced air to the foam generating device, wherein the means for heating the forced air is positioned in the forced air duct;
second conveying means for conveying the water from the means for heating the water to the forced air duct at a point upstream of the foam generating device and downstream of the means for heating the forced air;
means for transferring the foaming substance from the foaming substance containment tank to the second conveying means;
a first injection device configured to inject a mixture of water and foaming substance from the second conveying means into the forced air duct;
means for distribution of the foam; and
control means.

12. The apparatus of claim 11, wherein the control means determines switch on/switch off of the means for heating water according to calculated on/off cycles.

13. The apparatus of claim 11, wherein the control means determines switch on/switch off of the means for heating water according to on/off cycles calculated in real time as a function of an inlet temperature of the water into the means for heating water, and/or an outlet temperature of the water from the means for heating water, and/or a desired temperature of water delivered from the means for heating water.

14. The apparatus of claim 11, comprising third conveying means of the water connecting a point of the second conveying means upstream of an inlet of the means for transferring the foaming substance with the forced air duct at a point downstream of the means for heating the forced air and upstream of the first injection device.

15. The apparatus of claim 14, comprising a second injection device configured to inject water from the third conveying means into the forced air duct.

16. The apparatus of claim 15, wherein the first injection device and/or the second injection device comprises one or more nebulizing/atomizing nozzles of the mixture of water and foaming substance and/or of the water.

17. The apparatus of claim 11, comprising a first recirculation line of the water from the second water conveying means to the water containment tank.

18. The apparatus of claim 11, comprising a second water recirculation line of the water from the first water conveying means to the water containment tank.

19. The apparatus of claim 11, wherein the first injection device comprises one or more nebulizing/atomizing nozzles of the mixture of water and foaming substance and/or of the water.

20. The apparatus of claim 11, comprising means for operational coupling with a means of transport.

21. The apparatus of claim 11, wherein the control means are operatively connected to the water containment tank, and/or to the means for heating the water, and/or to the foaming substance containment tank, and/or to the means for generating forced air, and/or to the means for heating the forced air, and/or to the foam generating device, and/or to the first conveying means, and/or to the second conveying means, and/or to the means for transferring the foaming substance, and/or to the first injection device, and/or to the second injection device, and/or to the means for distribution.

21. A method of operating an apparatus for mobile weed control and/or desuckering of tree crops, the method comprising:
conveying water from a first containment tank of the apparatus to a first heating area, wherein the water is heated;
conveying heated water from the first heating area and simultaneously introducing a foaming substance from a second containment tank to the heated water from the first heating area;
forcing air via a first input into a duct comprising a second heating area wherein the forced air is heated, further wherein the duct connects at an output into a foam generator;
injecting a mixture of foaming substance and heated water from the first heating area into the duct via a second input, at a point upstream of the foam generator and downstream of the second heating area; and
distributing foam from the foam generator.

22. The method of claim 21, wherein the apparatus is mounted on a transport vehicle, and wherein foam generator is positioned laterally with respect to the transport vehicle and the foam is distributed from the foam generator in a direction substantially perpendicular to a direction of travel of the transport vehicle.

23. The method of claim 21, further comprising controlling switch on/switch off of the heating of the water in the first heating area according to calculated on/off cycles.

24. The method of claim 21, further comprising controlling switch on/switch off of the heating of the water in the first heating area according to on/off cycles calculated in real time as a function of an inlet temperature of the water into the first heating area, and/or an outlet temperature of the water from the first heating area, and/or a desired temperature of water delivered from the first heating area.

25. The method of claim 21, comprising recirculating of water, having been conveyed from the first heating area and prior to injection into the duct via the second input, to the first containment tank.

26. The method of claim 25, wherein the recirculating step is performed during a pre-heating process and until a predetermined operating temperature is reached.

27. The method of claim 21, comprising recirculating of water, having been conveyed from the first containment tank and prior to the first heating area, to the first containment tank.

28. The method of claim 27, wherein the recirculating step is performed during an interruption in the mobile weed control and/or desuckering operations, further wherein heating of the water in the first heating area is temporarily disabled.
